(19) United States
(12) Patent Application Publication
(10) Pub. No.: US 2014/0103098 A1
(43) Pub. Date: Apr. 17, 2014

(54) MASK FOR BUMPING SOLDER BALLS ON CIRCUIT BOARD AND SOLDER BALL BUMPING METHOD USING THE SAME

(71) Applicant: SAMSUNG ELECTRO-MECHANICS CO., LTD., Suwon (KR)

(72) Inventors: Jin Won Choi, Suwon (KR); Yon Ho YOU, Suwon (KR); Seon Jae MUN, Suwon (KR); Noriaki MUKAI, Suwon (KR); Seung Wan KIM, Suwon (KR); KiJu LEE, Suwon (KR); Jung In CHOI, Suwon (KR)

(73) Assignee: SAMSUNG ELECTRO-MECHANICS CO., LTD., Suwon (KR)

(21) Appl. No.: 14/048,839

(22) Filed: Oct. 8, 2013

(30) Foreign Application Priority Data
Oct. 11, 2012 (KR) 10-2012-0112966

(51) Int. Cl. B23K 3/06; B23K 3/08

(52) U.S. Cl. CPC B23K 3/06; B23K 3/082
USPC 228/223; 228/41

(57) ABSTRACT

Disclosed herein are a mask for bumping solder balls on a circuit board and a solder ball bumping method using the same. The mask includes: a plurality of openings providing spaces into which the solder balls are inserted to thereby be seated on solder pads; and trenches providing introduction spaces for spreading a flux to portions at which the solder balls are seated on the solder pads and extended from at least one side of circumferences of the openings.

### CROSS REFERENCE(S) TO RELATED APPLICATIONS

This application claims the benefit under 35 U.S.C. Section 119 of Korean Patent Application Serial No. 10-2012-0112966, entitled “Mask for Bumping Solder Balls on Circuit Board and Solder Ball Bumping Method Using the Same” filed on Oct. 11, 2012, which is hereby incorporated by reference in its entirety into this application.

### BACKGROUND OF THE INVENTION

1. Technical Field

The present invention relates to a mask for bumping solder balls on a circuit board and a solder ball bumping method using the same, and more particularly, to a mask for bumping a solder ball on a circuit board including a trench so as to provide an introduction space for spreading a flux, and a solder ball bumping method using the same.

2. Description of the Related Art

Recently, application of a flip chip scheme of forming a solder bump on a printed circuit board (PCB) and connecting a device onto the solder bump has gradually increased. Particularly, in the case of a central processing unit (CPU) and a graphic calculating apparatus calculating large capacity data at a high speed, application of a flip chip scheme of connecting a substrate and a device to each other by a solder instead of a technology of connecting the substrate and the device to each other using a wire to improve connection resistance has rapidly increased.

A method of forming the solder bump on the substrate in order to connect the chip and the substrate to each other may be divided into a method of forming a solder bump by printing a solder paste on the substrate and reflowing the solder paste, a method of forming a solder bump by mounting a fine solder ball on the substrate, and a method of forming a solder bump by injecting a melted solder onto the substrate directly or using a mask. The solder bump formed on the substrate as described above is melted for connection with Cu or a solder bump formed on the chip, such that bonding between metals is made.

In the case of a pick & place scheme that is mainly used, which is a scheme of forming a vacuum hole in a jig so as to be the same as a substrate pattern and picking up a solder ball in a vacuum and then placing the solder ball on a substrate, only solder balls having the same size may be mounted. A ball placing scheme is a scheme of forming an opening part having the same size in a metal mask and then squeegeeing a solder ball using a metal or urethane squeegee to mount the solder ball on an I/O pad of a substrate through the opening part of the metal mask.

Recently, in accordance with an increase in the request for a fine pitch product, research into various types of bumping technologies of improving the pick & place scheme or the ball placing scheme has been conducted.

FIG. 5 is a view schematically showing a form in which a mask for bumping solder balls on a circuit board according to the related art is applied; and FIG. 6 is a view schematically showing a cross section of the form in which the mask for bumping solder balls on a circuit board shown in FIG. 5 is applied.

A representative example of the ball placing scheme is a scheme of forming a mask on a surface of a substrate using a photosensitive dry film (DF), squeegeeing a solder ball to mount the solder ball in the photosensitive DF, and then applying and reflowing a flux to form a bump. In this case, a mask as shown in FIG. 5 has been used. However, as a bump pitch is decreased to a fine pitch, a size of a used solder ball has decreased to 100 μm or less. As a size of an opening of the DF for mounting the solder ball having the decreased size becomes very small, for example, 1.2 times larger than the size of the solder ball, even after a flux is applied, the flux is not transferred to the solder ball and the I/O pad, such that a void 50 as shown in FIG. 6 is formed. Therefore, there is a problem that the solder ball is not connected to the I/O pad of the substrate.

In a bumping method of forming a bump by forming a DF mask on a substrate and mounting a solder ball in the DF mask, a flux is applied in a printing or spray scheme in the state in which a solder ball is inserted into a limited space in a DF opening 30a as shown in FIG. 5. Therefore, the solder ball reacts to the I/O pad 10 of the substrate, such that it is difficult to apply a required amount of flux 40 for forming a bump having high reliability. In order to use a flux including a sufficient amount of activator, a flux 40 having a high solid component content, that is, high viscosity should be used. However, a high viscosity flux has a disadvantage in that it does not flow up to a lower portion of the solder ball 1 and the I/O pad 10 of the substrate. Meanwhile, in the case of using a flux of which viscosity is decreased by decreasing a solid component and increasing a content of an organic solvent, in order to secure a sufficient activator, after the flux is sprayed, the organic solvent should be volatilized and the flux should be again sprayed. As a result, productivity becomes low. In addition, since the DF made of a polymer is exposed to the organic solvent for a long period of time, coupling force of the DF becomes weak, such that the DF is separated from the surface of the substrate or the mask is separated during a reflow process to cause a defect.

### RELATED ART DOCUMENT

### Patent Document

(Patent Document 1) Korean Patent Laid-Open Publication No. 10-2011-0128737 (laid-open published on Nov. 11, 2011)

### SUMMARY OF THE INVENTION

An object of the present invention is to provide a mask for bumping solder balls on a circuit board capable of securing a volume required for injecting and spreading a flux required for bonding the solder balls and a substrate pad to each other by forming a trench in a mask surface, and a solder ball bumping method using the same.

According to an exemplary embodiment of the present invention, there is provided a mask for bumping solder balls on a circuit board, including: a plurality of openings providing spaces into which the solder balls are inserted to thereby be seated on solder pads; and trenches providing introduction spaces for spreading a flux to portions at which the solder balls are seated on the solder pads and extended from at least one side of circumferences of the openings.

The trench may be formed to connect one opening and another opening to each other.

The trench may be connected to two or four other openings around the circumference of one opening.

The opening may have a size larger than that of the solder ball and smaller than that of the solder pad.

The mask may be used for fine pitch bumping using the solder ball having a size of 100 μm or less.

The mask may be a dry film mask.

The mask may be attached onto a solder resist having open regions so that the solder pads on the circuit board are exposed.

According to another exemplary embodiment of the present invention, there is provided a solder ball bumping method including: forming a mask on a solder resist having open regions so that solder pads on a circuit board are exposed, the mask including a plurality of openings exposing the solder pads and trenches extended from at least one side of circumferences of the openings so that a flux is spread to portions at which solder balls are to be seated on the solder pads exposing the solder resist; placing the solder balls on the solder pads through the plurality of openings of the mask; and injecting the flux into the portions at which the solder balls are seated on the solder pads through the trenches of the mask.

In the forming of the mask, the trench may be formed to connect one opening and another opening to each other.

In the forming of the mask, the trench may be connected to two or four other openings around the circumference of one opening.

The solder ball bumping method may be a fine pitch bumping method using the solder ball having a size of 100 μm or less.

The mask may be formed on the solder resistor on which a solder mask defined (SMD) type of solder pad of which an outer side is covered by the solder resist is formed.

The mask may be formed on the solder resist on which a non solder mask defined (NSMD) type of solder pad of which the entire upper surface is exposed is formed.

The solder ball bumping method may further include, after the injecting of the flux, bonding the solder balls seated on the solder pads.

The solder ball bumping method may further include, after the bonding of the solder balls, removing the mask.

In the removing of the mask, the flux around the bonded solder bump may be removed.

### BRIEF DESCRIPTION OF THE DRAWINGS

FIG. 1 is a view schematically showing a form in which a mask for bumping solder balls on a circuit board according to an exemplary embodiment of the present invention is applied;

FIG. 2 is a view schematically showing a cross section of the form in which the mask for bumping solder balls on a circuit board shown in FIG. 1 is applied;

FIGS. 3A to 3C are views schematically showing a form in which a mask for bumping solder balls on a circuit board according to another exemplary embodiment of the present invention is applied;

FIGS. 4A to 4E are views schematically showing a solder ball bumping method for bumping solder balls on a circuit board according to another exemplary embodiment of the present invention;

FIG. 5 is a view schematically showing a form in which a mask for bumping solder balls on a circuit board according to the related art is applied; and

FIG. 6 is a view schematically showing a cross section of the form in which the mask for bumping solder balls on a circuit board shown in FIG. 5 is applied.

### DESCRIPTION OF THE PREFERRED EMBODIMENTS

Exemplary embodiments of the present invention for accomplishing the above-mentioned objects will be described with reference to the accompanying drawings. In the present specification, the same reference numerals will be used to describe the same components, and a detailed description thereof will be omitted in order to allow those skilled in the art to easily understand the present invention.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween.

Although a singular form is used in the present description, it may include a plural form as long as it is opposite to the concept of the present invention and is not contradictory in view of interpretation or is used as a clearly different meaning. It should be understood that “include”, “have”, “comprise”, “be configured to include”, and the like, used in the present description do not exclude presence or addition of one or more other characteristic, component, or a combination thereof.

The accompanying drawings referred in the present description may be ideal or abstract examples for describing exemplary embodiments of the present invention. In the accompanying drawings, a shape, a size, a thickness, and the like, may be exaggerated in order to effectively describe technical characteristics.

First, a mask according to a first exemplary embodiment of the present invention will be described in detail with reference to the accompanying drawings. Here, reference numerals that are not denoted in the accompanying drawings may be reference numerals in other drawings showing the same components.

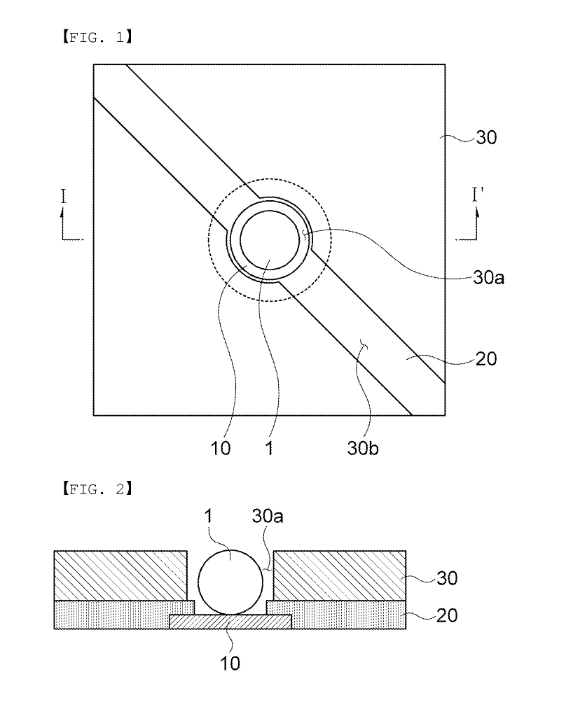

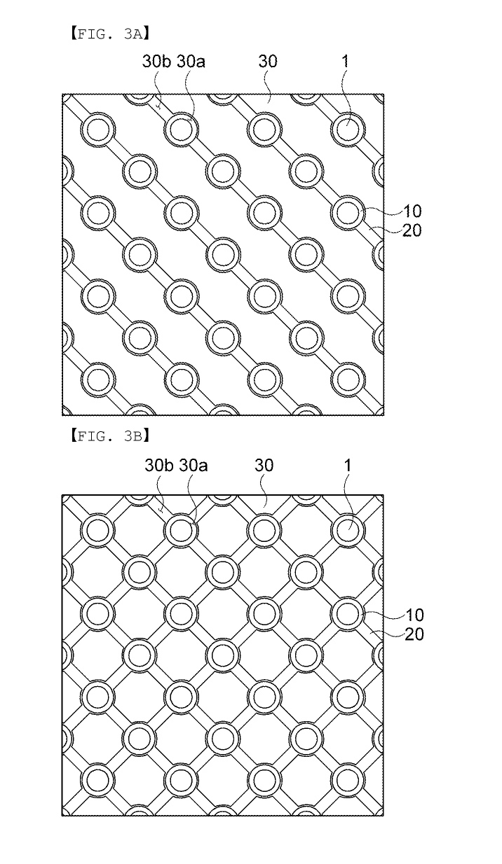

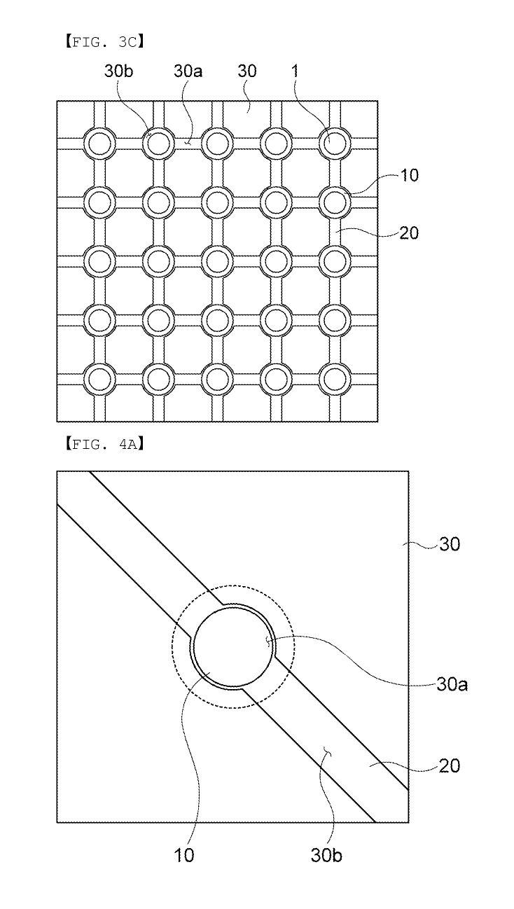

FIG. 1 is a view schematically showing a form in which a mask for bumping solder balls on a circuit board according to an exemplary embodiment of the present invention is applied; FIG. 2 is a view schematically showing a cross section of the form in which the mask for bumping solder balls on a circuit board shown in FIG. 1 is applied; and FIGS. 3A to 3C are views schematically showing a form in which a mask for bumping solder balls on a circuit board according to another exemplary embodiment of the present invention is applied.

Referring to FIGS. 1 to 3C, the mask 30 for bumping solder balls on a circuit board according to the exemplary embodiment of the present invention is used to bump the solder balls 1 on solder pads 10 of a circuit board (not shown). The mask 30 according to the exemplary embodiment of the present invention is used to bump the solder balls 1 on the circuit board (not shown) and is removed after bumping and bonding the solder balls 1, unlike a solder resist 20. Here, the mask 30 includes a plurality of openings 30a and trenches 30b.

For example, the mask 30 may be attached onto the solder resist 20 having open regions so that the solder pads 10 on the circuit board (not shown) are exposed.

Referring to FIGS. 1 to 3C, the plurality of openings 30a provide spaces into which the solder balls 1 are inserted to thereby be seated on the solder pads 10.

Referring to FIGS. 1 and 2, as an example, the opening 30a may have a size larger than that of the solder ball 1 or smaller than that of the solder pad 10. Although not shown, as another example, the opening 30a may also have a size larger than that of the solder pad 10. For example, although not shown, in the case of a non solder mask defined (NSMD) type solder pad, the opening 30a of the mask 30 may also have a size larger than that of the solder pad 10.

In addition, referring to FIGS. 1 to 3C, the trench 30b provides an introduction space for spreading a flux 40 to a portion at which the solder ball 1 is seated on the solder pad 10 and is formed to be extended from at least one side of a circumference of the opening 30a.

Referring to FIGS. 3A to 3C, as an example, the trench 30b may be formed to connect one opening 30a and another opening 30a to each other.

In addition, referring to FIGS. 3A to 3C, as an example, the trench 30b may be connected to two or four other openings 30a around the circumference of one opening 30a.

Further, as an example, the mask 30 may be used for fine pitch bumping using the solder ball 1 having a size of 100 μm or less.

Further, as an example, the mask 30 may be a dry film (DF) mask. Here, the DF mask may be made of a polymer material, for example, a photosensitive polymer material.

According to the first exemplary embodiment of the present invention, in the case of the mask 30 in which the trench 30b is formed since a volume required in a flux injection process may be secured, a low viscosity flux 40 having a low solid component content and a high organic solvent content may be used without being repeatedly applied. In addition, since the volume required in the flux injection process may be secured to allow the flux to be smoothly injected and/or spread, it is possible to solve a bump missing problem that may be generated since the flux 40 is not smoothly spread in the case in which the trench 30b is not formed, such that reaction force between the solder pad 10 of the substrate and the solder ball 1 becomes insufficient due to an insufficient amount of flux 40.

Further, since the trench 30b in the surface of the mask 30 may be used as a path through which gas generated from the flux 40 in a reflow process is discharged, it is possible to solve a bump missing problem that may be generated since the gas generated in the reflow process is not discharged in the case in which the trench 30b is not formed, such that the generated gas pushes the mounted solder ball 1 toward the outside of the mask 30.

That is, according to the exemplary embodiment of the present invention, the bump missing that may be generated in the case in which the trench 30b is not formed may be prevented, such that process yield and productivity may be improved.

In addition, according to the exemplary embodiment of the present invention, even in the case in which the flux 40 is partially non-uniformly applied during a process of being applied by a spray method, or the like, the flux 40 may be uniformly applied through the trenches 30b connected to one another like a waterway.

Next, a solder ball bumping method according to another exemplary embodiment of the present invention will be described in detail with reference to the accompanying drawings. Here, the mask 30 according to the first exemplary embodiment of the present invention described above may be referred. Therefore, an overlapped description will be omitted.

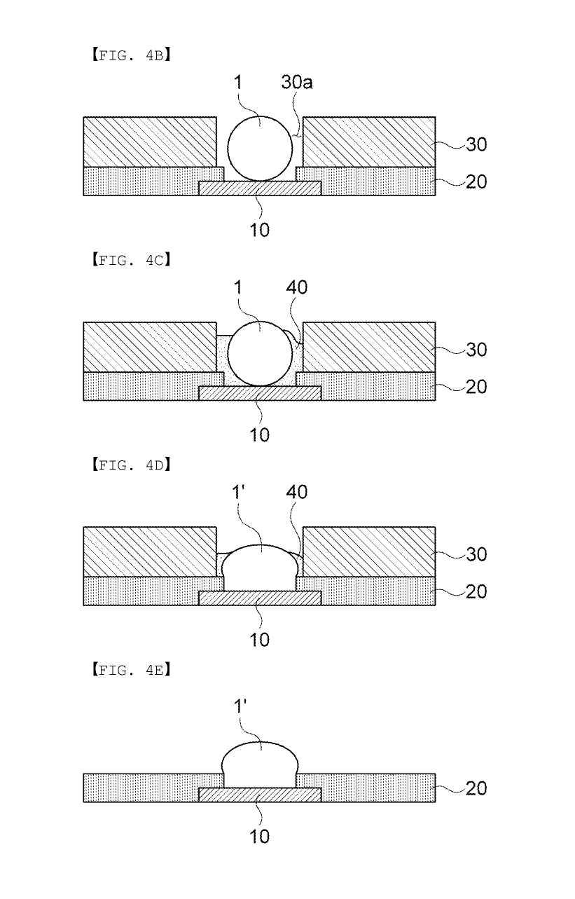

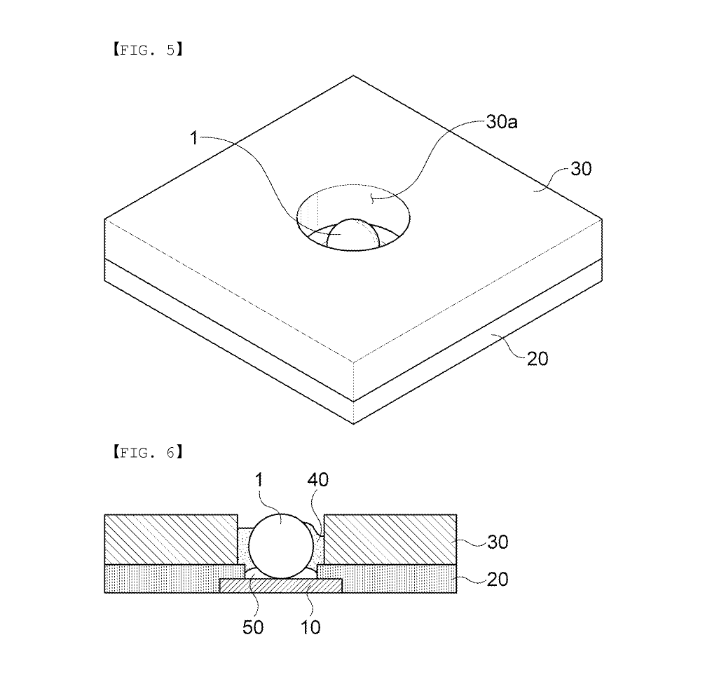

FIGS. 4A to 4E are views schematically showing a solder ball bumping method for bumping solder balls on a circuit board according to another exemplary embodiment of the present invention.

Referring to FIGS. 4A to 4C, the solder ball bumping method according to another exemplary embodiment of the present invention may include forming a mask (See FIG. 4A), placing solder balls (See FIG. 4B), and injecting a flux (See FIG. 4C). Here, the mask 30 may be a dry film mask, for example, a photosensitive dry film mask made of a polymer.

In addition, referring to FIG. 4D, as an example, the solder ball bumping method may further include bonding solder balls, and referring to FIG. 4E, as an example, the solder ball bumping method may further include removing the mask.

As an example, the solder ball bumping method using the mask 30 may be a fine pitch bumping method using the solder ball 1 having a size of 100 μm or less.

Referring to FIG. 4A, in the forming of the mask, the mask 30 is formed on a solder resist 20 having open regions so that solder pads 10 on a circuit board (not shown) are exposed. Here, the mask 30 includes a plurality of openings 30a exposing regions of solder pads 10 into which the solder balls 1 are to be inserted and trenches 30b extended from at least one side of circumferences of the openings 30a and exposing the solder resist 20. That is, the plurality of openings 30a exposing the regions of the solder pads 10 into which the solder balls 1 are to be inserted and the trenches 30b extended from at least one side of the circumferences of the openings 30a so that the flux 40 may be spread to portions at which the solder balls 1 are to be seated on the solder pads 10 and exposing the solder resist 20 are formed on the mask 30.

Here, as an example, in the forming of the trench 30b, the trench 30b may be formed to connect one opening 30a and another opening 30a to each other.

In addition, as an example, in the forming of the trench 30b, the trench 30b may be formed to be connected to two or four other openings 30a around the circumference of one opening 30a.

According to the exemplary embodiment of the present invention, the trench 30a is formed in the mask 30, thereby making it possible to secure a space capable of storing the flux 40 required for bonding the solder ball 1 and the solder pad 10 of the substrate to each other by a metal reaction.

In addition, in the case in which the flux 40 is non-uniformly applied, the flux 40 may be moved through the trench 30b to thereby be uniformly applied.

Further, in a reflow process for melting the solder ball 1, gas discharged from the flux 40 may be smoothly discharged through the trench 30b of the mask 30.

In addition, referring to FIG. 4A or FIGS. 4B and 4C, as an example, the mask 30 may be formed on the solder resistor 20 on which a solder mask defined (SMD) type of solder pad 10 or solder land of which an outer side is covered by the solder resist 20 is formed. In this case, the opening of the mask 30 may have a size larger than that of the solder ball 1 and smaller than that of the solder pad 10. Alternatively, the opening of the mask 30 may also have a size equal to or larger than that of the solder pad 10.

Alternatively, although not shown, as another example, the mask may be formed on the solder resist 20 on which a non solder mask defined (NSMD) type of solder pad 10 or solder land of which the entire upper surface is exposed is formed. In this case, the opening of the mask may have a size larger than that of the solder pad 10 or smaller than or equal to the solder pad 10.

Next, referring to FIG. 4B, in the placing of the solder balls, the solder balls 1 are placed on the solder pads 10 through the plurality of openings 30a of the mask 30.

Next, referring to FIG. 4C, in the injecting of the flux, the flux 40 is injected into the portions at which the solder balls 1 are seated on the solder pads 10 through the trenches 30b of the mask 30.

Next, another example of a solder ball bumping method according to a second exemplary embodiment of the present invention will be described with reference to FIG. 4D.

Here, the solder ball bumping method according to another example may further include bonding the solder balls. In the bonding of the solder balls of FIG. 4D, the solder balls 1 seated on the solder pads 10 are bonded after the injecting of the flux. For example, the solder balls 1 may be bonded onto the solder pads 10 in the reflow process.

In addition, describing still another example with reference to FIG. 4E, the solder ball bumping method according to still another example may further include removing the mask.

In the removing of the mask of FIG. 4E, the mask 30 may be removed after the bonding of the solder balls.

As an example, in the removing of the mask, the flux 40 around the bonded solder bump 1′ may also be removed.

According to the second exemplary embodiment of the present invention, the mask 30 in which the trench 30b is formed is used, thereby making it possible to secure a volume required in a flux injection process. Therefore, since the flux may be smoothly injected and/or spread, it is possible to solve a bump missing problem that may be generated since the flux 40 is not smoothly spread in the case in which the trench 30b is not formed, such that reaction force between the solder pad 10 of the substrate and the solder ball 1 become insufficient due to an insufficient amount of flux 40.

Further, since the trench 30b of the mask 30 may be used as a gas discharging path in the reflow process is discharged, it is possible to solve a bump missing problem that may be generated since the gas generated in the reflow process is not discharged in the case in which the trench 30b is not formed, such that the generated gas pushes the mounted solder ball 1 toward the outside of the mask 30.

In addition, according to the exemplary embodiment of the present invention, even in the case in which the flux 40 is partially non-uniformly applied during a process of being applied by a spray method, or the like, the flux 40 may be uniformly applied through the trenches 30 connected to one another like a waterway.

According to the exemplary embodiment of the present invention, the trench is formed in the surface of the mask, thereby making it possible to secure a volume required for injecting or spreading the flux for bonding the solder ball and the substrate pad to each other.

In addition, according to the exemplary embodiment of the present invention, since the volume required for injecting or spreading the flux may be secured by the trench of the mask, a low viscosity flux having a low solid component content and a high organic solvent content may be used without being repeatedly applied.

In addition, since the volume required in the flux injection process may be secured to allow the flux to be smoothly injected and/or spread, it is possible to solve the bump missing problem that may be generated since the flux is not smoothly spread in the case in which the trench is not formed, such that reaction force between the solder pad of the substrate and the solder ball becomes insufficient due to an insufficient amount of flux.

Further, according to the exemplary embodiment of the present invention, since the trench of the mask may be used as the path through which the gas generated from the flux in a reflow process is discharged, it is possible to solve the bump missing problem that may be generated since the gas generated in the reflow process is not discharged in the case in which the trench is not formed, such that the generated gas pushes the mounted solder ball 1 toward the outside of the mask.

Furthermore, the bump missing may be prevented, such that the process yield and the productivity may be improved.

Furthermore, according to the exemplary embodiment of the present invention, even in the case in which the flux is partially non-uniformly applied during a process of being applied by the spray method, or the like, the flux may be uniformly applied through the trenches connected to one another like a waterway.

It is obvious that various effects directly stated according to various exemplary embodiments of the present invention may be derived by those skilled in the art from various configurations according to the exemplary embodiments of the present invention.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

1. A mask for bumping solder balls on a circuit board, comprising:
a plurality of openings providing spaces into which the solder balls are inserted to thereby be seated on solder pads; and
trenches providing introduction spaces for spreading a flux to portions at which the solder balls are seated on the solder pads and extended from at least one side of circumferences of the openings.

2. The mask according to claim 1, wherein the trench is formed to connect one opening and another opening to each other.

3. The mask according to claim 2, wherein the trench is connected to two or four other openings around the circumference of one opening.

4. The mask according to claim 1, wherein the opening has a size larger than that of the solder ball and smaller than that of the solder pad.

5. The mask according to claim 1, wherein the opening has a size larger than that of the solder pad.

6. The mask according to claim 1, wherein it is used for fine pitch bumping using the solder ball having a size of 100 μm or less.

7. The mask according to claim 1, wherein it is a dry film mask.

8. The mask according to claim 1, wherein it is attached onto a solder resist having open regions so that the solder pads on the circuit board are exposed.

9. A solder ball bumping method comprising:
forming a mask on a solder resist having open regions so that solder pads on a circuit board are exposed, the mask including a plurality of openings exposing the solder pads and trenches extended from at least one side of circumferences of the openings so that a flux is spread to portions at which solder balls are to be seated on the solder pads exposing the solder resist;
placing the solder balls on the solder pads through the plurality of openings of the mask; and
injecting the flux into the portions at which the solder balls are seated on the solder pads through the trenches of the mask.

10. The solder ball bumping method according to claim 9, wherein in the forming of the mask, the trench is formed to connect one opening and another opening to each other.

11. The solder ball bumping method according to claim 10, wherein in the forming of the mask, the trench is connected to two or four other openings around the circumference of one opening.

12. The solder ball bumping method according to claim 9, wherein it uses the solder ball having a size of 100 μm or less.

13. The solder ball bumping method according to claim 9, wherein the mask is formed on the solder resistor on which a solder mask defined (SMD) type of solder pad of which an outer side is covered by the solder resist is formed.

14. The solder ball bumping method according to claim 9, wherein the mask is formed on the solder resist on which a non solder mask defined (NSMD) type of solder pad of which the entire upper surface is exposed is formed.

15. The solder ball bumping method according to claim 9, further comprising, after the injecting of the flux, bonding the solder balls seated on the solder pads.

16. The solder ball bumping method according to claim 15, further comprising, after the bonding of the solder balls, removing the mask.

17. The solder ball bumping method according to claim 16, wherein in the removing of the mask, the flux around the bonded solder bump is removed.
